(19) United States
(12) Patent Application Publication
(10) Pub. No.: US 2024/0324077 A1
(43) Pub. Date: Sep. 26, 2024

(54) POWER SUPPLY DEVICE FOR METALLURGICAL EQUIPMENT

(71) Applicant: Badische Stahl-Engineering GmbH, Kehl (DE)

(72) Inventor: Dirk RIEDINGER, Kehl (DE)

(21) Appl. No.: 18/612,160

(22) Filed: Mar. 21, 2024

(30) Foreign Application Priority Data
Mar. 22, 2023 (EP) 23163421.3

(51) Int. Cl. H05B 7/144; C21C 5/52; H01F 27/16

(52) U.S. Cl. CPC H05B 7/144; C21C 5/52; H01F 27/16

(57) ABSTRACT

A power supply device is provided for metallurgical equipment, which is to be operated with electric energy with a non-linear load and has a maximum power consumption equal to or greater than 180 MVA, such as for an electric arc furnace having a power consumption equal to or greater than 180 MVA. In such a power supply device, at least two structurally equivalent three-phase furnace transformers (100, 200) having an output power rating equal to or greater than 90 MVA include a delta interconnection (D) on the input side thereof and an external interconnection (iii) on the output side thereof. A low voltage-side parallel circuit (400) of output-side low voltage connectors of the furnace transformers (100, 200) includes symmetrized external delta interconnections implemented as water-cooled high current conductors. The low voltage-side parallel circuit is connectable in an electrically symmetrized manner to electrodes of the metallurgical equipment (10).

### CROSS-REFERENCE

The present application claims priority to European patent application serial number 23 163 421.3 filed on 22 Mar. 2023, the contents of which are incorporated fully herein by reference.

### TECHNICAL FIELD

The present invention generally relates to a power supply device for metallurgical equipment to be operated (powered) with electric energy (current) with a non-linear load, such as an electric arc furnace having a maximum power consumption equal to or greater than 180 MVA (mega volt-amperes).

### BACKGROUND ART

Power supply devices for metallurgical equipment to be operated with electric energy are known from EP 3 943 853 A1 (U.S. Pat. No. 11,320,203 B2), WO 2021/130791 A1, U.S. Pat. No. 11,346,605 B2, US 2022/0412651 A1, WO 2021/161355 A1, EP 4 110 015 A1, WO 2015/176899 A1, EP 1 026 921 B1, and FR 2 926 182 A1. In particular, WO 2007/014535 A1 discloses a transformer system for an electric arc furnace having three electrodes. This transformer system comprises at least two three-phase transformers, which are internally delta connected, connected in parallel to the electrodes, and can be switched on and off depending on each other.

In the European steel industry, to achieve reduced or even zero carbon emissions, a transformation has begun from an integrated route of steel production using blast furnaces and converters toward an electrical steel route using electric arc furnaces (EAFs) for scrap and H₂-based direct reduced iron (DRI), which is also known as sponge iron, in briquetted form (also called HBI=Hot Briquetted Iron). Currently, the proportion of the electrical steel route, e.g., in Germany is about 30%. This proportion is expected to possibly increase to 100% by the mid-2030s to realize the desired CO₂ emissions reduction. The current tapping masses of known converters are around 150 t to 250 t (hereinafter, “t”=metric ton(s) unless otherwise noted) and cannot be changed due to the necessary maintenance (continued usage) of the installed ladles and casting systems and due to the required level of productivity. This has consequences for the design of electric arc furnaces that will replace such converters.

### SUMMARY

It is one non-limiting object of the present teachings to disclose techniques for improving a power supply for metallurgical equipment, such as an electric arc furnace, to be operated with electric energy (current) with a non-linear load, in particular for an electric arc furnace to be used (retrofitted) in an existing facility instead of (e.g., to replace) a blast furnace and a converter.

In one aspect of the present teachings, a power supply device for metallurgical equipment, which is to be operated with electric energy (current) with a non-linear load and has a maximum (rated) power consumption equal to or greater than 180 MVA, such as an electric arc furnace having a (rated) power consumption equal to or greater than 180 MVA, may comprise:
at least two structurally equivalent three-phase furnace transformers each having an output power rating equal to or greater than 90 MVA, each furnace transformer comprising an input-side three-phase medium voltage connector and a delta connection configuration (delta interconnection) on the input side thereof, and an output-side three-phase low voltage connector and an external connection configuration on the output side thereof;
at least one medium voltage furnace bar (busbar, electrical rail) connected to the input-side three-phase medium voltage connectors of the at least two furnace transformers; and
a low voltage-side parallel circuit connecting the output-side low voltage connectors of the at least two furnace transformers via symmetrized external delta connection configurations (delta interconnections) implemented as water-cooled high current conductors, the low voltage-side parallel circuit being configured to be connectable to electrodes of the metallurgical equipment.

In one embodiment of the above-described aspect, the power supply device may preferably further comprise a high voltage supply bar, and at least two structurally equivalent supply transformers having an output power rating equal to or greater than 90 MVA, each supply transformer comprising an input-side high voltage connector and an output-side medium voltage connector. The input-side high voltage connectors of the supply transformers are connected to the high voltage supply bar. In addition, the output-side medium voltage connectors of the supply transformers are connected to the at least one medium voltage furnace bar.

In another embodiment of the above-described aspect, the power supply device may preferably comprise at least two medium voltage furnace bars, which are respectively connected to the two input-side three-phase medium voltage connectors of the at least two furnace transformers.

In such an embodiment, the power supply device may preferably further comprise a high voltage supply bar, and at least two structurally equivalent supply transformers each having an output power rating equal to or greater than 90 MVA. Each supply transformer comprises an input-side high voltage connector and an output-side medium voltage connector. The input-side high voltage connectors of the supply transformers are both connected to the high voltage supply bar. Furthermore, the output-side medium voltage connectors of the at least two supply transformers are respectively connected to the at least two medium voltage furnace bars.

In addition or in the alternative to the preceding embodiments, the power supply device may preferably further comprise at least one non-active current compensation (e.g., at least one non-active compensator) per medium voltage furnace bar. The non-active current compensation(s) (non-active compensator(s)) is (are respectively) connected to the medium voltage furnace bar(s). The non-active current compensation(s) (non-active compensator(s)) preferably is/are configured as one or more semiconductor-based non-active current compensations (compensators).

In addition or in the alternative to the preceding embodiments, the water-cooled high current conductors are configured as water-cooled copper pipes respectively connected for (to) each of the three phases, each having one loop of predetermined length such that the predetermined lengths of the high current conductors within the three loops achieve electrical symmetrisation. As used herein, the term “node” means or represents a point of connection of two or more circuit elements, the term “loop” means or represents any closed path through a circuit in which no node is encountered more than once, and the term “branch” means or represents a portion of a circuit containing a single element and the nodes at each end of the single element. As will be discussed below with reference to FIG. 5, the delta connection of pairs of two of the open ends provides (results in) three pairwise connections at each transformer implemented by the water-cooled pipes, thereby implementing an external delta vector group connection. Each of the three pairwise connections is connected to another pairwise connection of the other transformer which has the same phase and to the one node of the three nodes which supplies the corresponding phase, thereby implementing the parallel connection of the external delta vector groups. Each parallel connection of the two pairwise connections forms one loop.

In addition or in the alternative to the preceding embodiments, the at least two three-phase furnace transformers preferably are arranged (disposed) opposing each other on a lateral side of the metallurgical equipment (such as an electric arc furnace) such that the output-side three-phase low voltage connectors oppose each other and the low voltage-side parallel circuit of the output-side low voltage connectors is preferably arranged (disposed) between the furnace transformers.

In addition or in the alternative to the preceding embodiments, the at least two medium voltage furnace bars preferably are each connected to an input-side medium voltage connector of a corresponding ladle furnace transformer.

In addition or in the alternative to the preceding embodiments, the at least two structurally equivalent three-phase furnace transformers preferably are of identical construction.

In addition or in the alternative to the preceding embodiments, the at least two structurally equivalent three-phase furnace transformers preferably are three-phase electric arc furnace transformers.

In addition or in the alternative to the preceding embodiments, two furnace transformers, which are small relative to the required total power, are connected in parallel.

With regard to the transformers, the expression “structurally equivalent” means that the transformers do not differ in their operational properties, functions, etc.; in addition, their masses and dimensions are at least substantially equal, e.g., within 20% of each other, more preferably within 10% of each other, and their connectors are functionally equivalent or interchangeable. This is naturally the case for structurally identical (identical) transformers. Therefore, “structurally equivalent transformers” are preferably structurally identical (or even completely identical). But transformers having minor differences, which do not result in different operational properties, functions, etc., are also encompassed by the term “structurally equivalent transformers”. Also, minor differences in the masses, dimensions, or connectors, which do not hinder the replaceability (interchangeability) of the transformers, are also encompassed by the term “structurally equivalent”.

The two structurally equivalent furnace transformers are provided with open secondary windings and are externally interconnected in a delta connection configuration according to the vector group designation “Diii0”. Here, it is noted that “D” means or represents “delta”, as in a delta or triangle electrical connection of the three phases, and D is capitalized because the delta connection configuration is on the high voltage side. Furthermore, “iii” means or represents the three open coil ends on the lower voltage side that are externally connected (i.e. connected outside the transformer). In addition, the “0” means or represents that there is no phase shift (i.e., zero degrees) between the voltages and the windings of the transformer.

The two external delta interconnections are connected in parallel at their corner points, i.e. connected in a particular manner via further conductors. Therefore, the conductors are required to conduct only half of the total electrode current up to the (external) connection of these conductors outside of the furnace transformers.

The conductor configuration of the low voltage-side parallel circuit, i.e. the arrangement and/or the configuration of the conductors in the high current system, can therefore be dimensioned smaller than in an embodiment, in which the entire electrode current has to be routed through one conductor along its entire length.

Such a design may be adapted to specific applications, e.g., by performing a simulation of the electrical network using a particular method for the field calculation of electromagnetic fields. In this case, the impedances of the high current system can be calculated with high accuracy with all current displacement effects (such as skin effects and proximity effects) and designed symmetrically.

Such an electrically symmetric design results, on average, in the same properties of the three electric arcs (power, radiation, length), and has significant advantages in operation.

Because the two structurally equivalent furnace transformers are configured with open secondary windings and are externally delta interconnected (vector group Diii0), the furnace transformers are structurally simpler and thereby more reliable, lighter and smaller.

A further advantage of such a parallel circuit of two structurally equivalent or structurally identical smaller furnace transformers, as compared to a single furnace transformer that is twice as powerful, is that the manufacturing of 90 to 150 MVA furnace transformers (i.e. rated output power: 90 to 150 MVA) is routine in comparison to manufacturing furnace transformers having a power rating of 180 MVA and more. There are presently several manufacturers, who can build such standard sizes up to 120 MVA and some up to 150 MVA.

Such transformers having comparably low, but still high, power ratings equal to or greater than 90 MVA are, furthermore, uncomplicated because they comprise, e.g., only one iron core with windings and no booster. The entire internal interconnection is simpler. This improves reliability relative to a single transformer having the required power rating.

The dimensions and the mass of single transformers having a comparably lower, but still high, power rating equal to or greater than 90 MVA are substantially smaller than those of a single big furnace transformer. A 100 MVA furnace transformer has a total mass of about 130 t and is relatively easily transportable as well as mountable and demountable, e.g., using the existing charging crane typically provided in a steel factory.

Furnace transformers corresponding more or less to a standard model are cheaper than specially manufactured and very large transformers. The manufacturing costs do not scale linearly with the rated power or the mass.

Because it is very unlikely that both structurally equivalent furnace transformers will fail (have to be taken out of service) at the same time, one structurally equivalent spare transformer is sufficient for the usual stockage of a replacement transformer. That is, e.g., three 100 MVA standard furnace transformers, i.e. two for the operation and one as a spare, are sufficient instead of two gigantic 200 MVA furnace transformers, i.e. one for the operation and one as a spare. The costs of three smaller standard furnace transformers are lower than the costs of two comparably very large non-standard furnace transformers. Moreover, the replacement of a defective transformer with a spare transformer is also much easier than for a single transformer having a power rating that is twice as high (e.g., ≥180 MVA).

When the two furnace transformers are arranged (disposed) such that the low voltage-side connectors oppose each other, this saves space and enables, in turn, an even easier replacement in case of one of the furnace transformers develops a defect and has to be removed from service for repair or replacement.

### BRIEF DESCRIPTION OF THE DRAWINGS

Further features, advantages and utilities result from the following description of embodiments with reference to the figures, in which:

FIG. 1 shows a power supply device for metallurgical equipment, namely an electric arc furnace, to be operated with electric energy with a non-linear load according to a first embodiment having one medium voltage furnace bar and a total power consumption of 200 MVA;

FIG. 2 shows a power supply device for metallurgical equipment, namely an electric arc furnace, to be operated with electric energy with a non-linear load according to a second embodiment having two medium voltage furnace bars and a total power consumption of 280 MVA;

FIG. 3 shows a schematic illustration of the electric connections of a part of an embodiment of a power supply device for an electric arc furnace having two structurally equivalent furnace transformers interconnected in parallel and one electric arc furnace;

FIG. 4 shows a secondary-side electrical equivalent circuit diagram (ECD) having furnace transformers interconnected in parallel;

FIG. 5 shows an electrically symmetric arrangement of water-cooled high current conductors in the secondary-side high current system of a low voltage-side parallel circuit of the output-side low voltage connectors of two structurally equivalent electric arc furnace transformers having a symmetrized external delta connection configuration (delta interconnections); and

FIG. 6 shows a schematic illustration of the electric connections of a part of a power supply device corresponding to the illustration of FIG. 3 with reference signs from FIG. 5.

### DETAILED DESCRIPTION

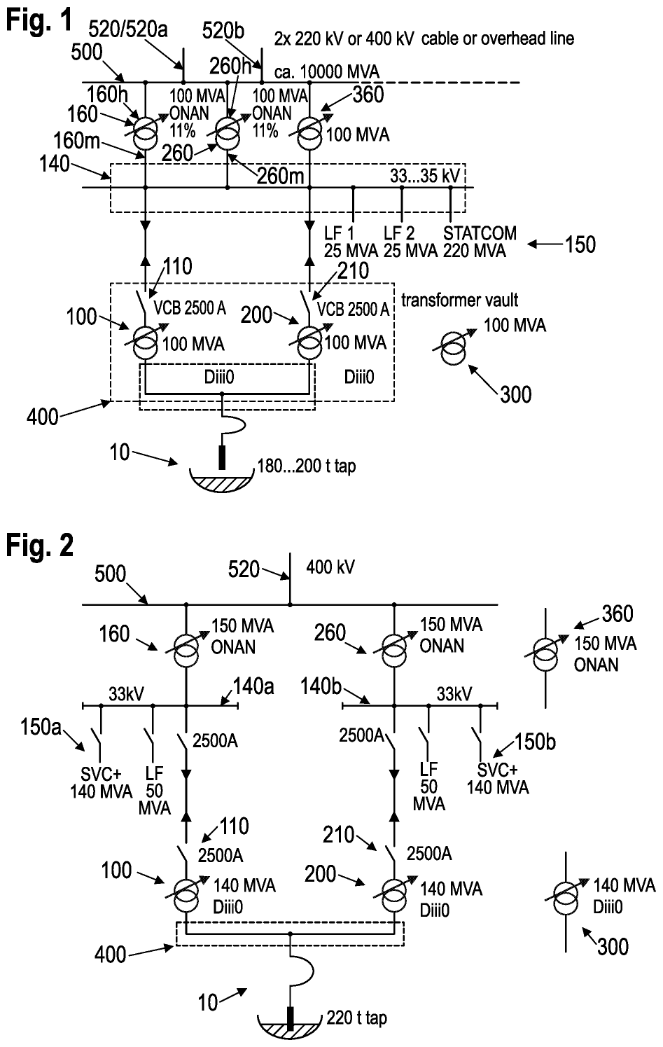

FIG. 1 shows a power supply device for metallurgical equipment, e.g., an electric arc furnace, to be operated with electric energy (current) with a non-linear load according to a first embodiment in a simplified one-line view. In the one-line view, the three phases of the three-phase electric power are represented by only one line instead of three lines. Throughout the present specification and in all embodiments of the present teachings, the input and output voltages of the transformers are always the three phases of a three-phase voltage that is shifted (phase-shifted) by 120°, unless something different is explicitly described or it is necessarily different such as for the output voltage for an output of a single phase.

The power supply device comprises a high voltage supply bar 500 connected to a common electric energy supply such as, e.g., a 400 kV line 520 or two 220 kV lines 520a, 520b in Europe or 500k V instead 400 kV and 230 k V instead 230 kV in the USA. In the following the European voltage levels are described but the US voltage levels could be used in an equivalent manner. The common electric energy supply supplies a three-phase voltage on each of the 400 kV line 520 and the two 220 kV lines 520a, 520b, respectively. The power supply device comprises at least two structurally equivalent supply transformers 160, 260, which each comprise an input-side high voltage connector 160h, 260h for the three phases and an output-side medium voltage connector 160m, 260m for the three phases. The inputs of the input-side high voltage connectors 160h, 260h are connected to the high voltage supply bar 500.

The power supply device comprises a medium voltage furnace bar 140. The outputs of the output-side medium voltage connector 160m, 260m of the supply transformers 160, 260 are connected to the medium voltage furnace bar 140. It is noted that the term “bar” used herein with regard to, in particular, the high voltage supply bar 500 and the medium voltage furnace bar 140 is intended to be synonymous with the terms “busbar” and “electrical rail” and thus denote a metal conductor having a cross-section that is sufficiently large to handle the transmission of high power (currents).

The power supply device comprises two structurally equivalent three-phase electric arc furnace transformers 100, 200, which are preferably structurally identical (e.g., completely identical) in the present embodiment.

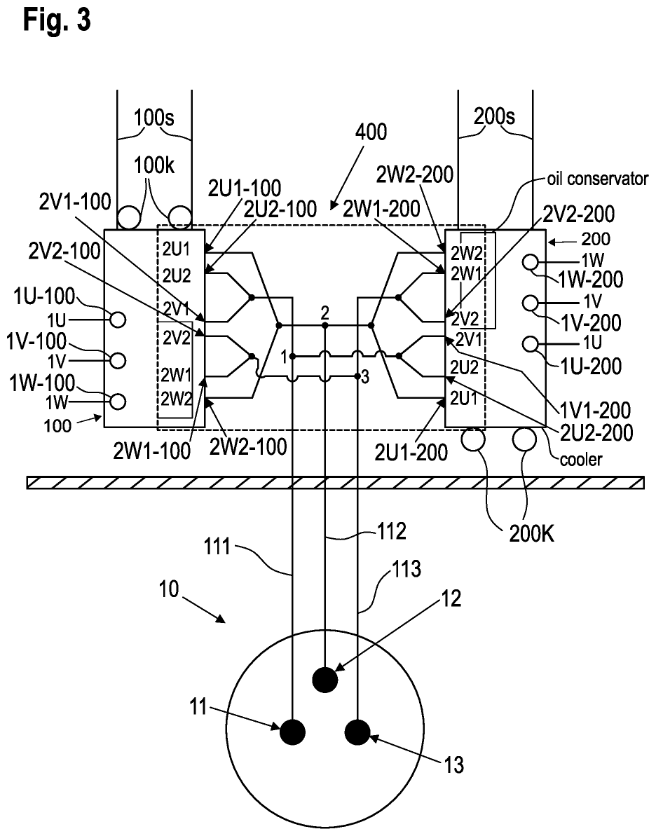

FIG. 3 schematically shows the electrical connections of a part of the power supply device for an electric arc furnace having two output-side furnace transformers 100, 200 interconnected in parallel and an electric arc furnace 10 according to a representative embodiment. Each of the two three-phase electric arc furnace transformers 100, 200 respectively comprises an input-side three-phase medium voltage connector 1U-100, 1V-100, 1W-100, and 1U-200, 1V-200, 1W-200, respectively, as shown in FIG. 3. Each of the two three-phase electric arc furnace transformers 100, 200 respectively comprises a delta interconnection (connection configuration) D on the input side. The medium voltage furnace bar 140 is connected to the input-side three-phase medium voltage connectors/inputs 1U-100, 1V-100, 1W-100, and 1U-200, 1V-200, 1W-200 of the electric arc furnace transformers 100, 200.

Such a medium voltage furnace bar 140 serves as a medium voltage switchgear, as it is basically also present in the prior art, but, in the present disclosure, it is provided for two furnace transformers 100, 200.

Each of the two three-phase electric arc furnace transformers 100, 200 respectively comprises an output-side three-phase low voltage connector 2U1-100, 2U2-100, 2V1-100, 2V2-100, 2W1-100, 2W2-100, and 2U1-200, 2U2-200, 2V1-200, 2V2-200, 2W1-200, 2W2-200, respectively, and an external interconnection iii on the output-side. This means, the two winding ends, i.e. winding start U1, V1, W1 and winding end U2, V2, W2, of all three windings U, V, W on the secondary side/output side (low voltage side) of the three-phase electric arc furnace transformers 100, 200 are routed outward out of the transformer, which is coded in a vector group as iii. This kind of connection and/or output is/are also referred to as open windings (i.e. open end windings).

The output-side low voltage connectors 2U1-100, 2U2-100, 2V1-100, 2V2-100, 2W1-100, 2W2-100, 2U1-200, 2U2-200, 2V1-200, 2V2-200, 2W1-200, 2W2-200 of the electric arc furnace transformers 100, 200 are externally, i.e. outside of the transformers, delta connected (interconnected) in a low voltage-side parallel circuit 400 such that the current flows are symmetrized. For this purpose, the impedances of the entire high current system, i.e. the low voltage-side connections, in which large (high) currents flow, are calculated with all current displacement effects (such as skin effects and proximity effects) and designed electrically symmetrical.

These external delta interconnections are realized with water-cooled high current conductors, which are respectively connected to three electrodes 11, 12, 13 of the metallurgical equipment (10), as will be described in more detail further below.

In greater detail, as illustrated in FIG. 3, a (first) winding start 2U1-100 of a first secondary-side winding 2U of the first electric arc furnace transformer 100 of the two electric arc furnace transformers 100, 200 is connected to a (third) winding end 2W2-100 of a third secondary-side winding 2W of the first electric arc furnace transformer 100. A (first) winding end 2U2-100 of the first secondary-side winding 2U of the first electric arc furnace transformer 100 is connected to a (second) winding start 2V1-100 of a second secondary-side winding 2V of the first electric arc furnace transformer 100. A (second) winding end 2V2-100 of the second secondary-side winding 2V of the first electric arc furnace transformer 100 is connected to a (third) winding start 2W1-100 of the third secondary-side winding 2W of the first electric arc furnace transformer 100.

In the same manner, in the second electric arc furnace transformer 200 of the two electric arc furnace transformers 100, 200, as also shown in FIG. 3, a (first) winding start 2U1-200 of a first secondary-side winding 2U of the second electric arc furnace transformer 200 is connected to a (third) winding end 2W2-200 of a third secondary-side winding 2W of the second electric arc furnace transformer 200. A (first) winding end 2U2-200 of the first secondary-side winding 2U of the second electric arc furnace transformer 200 is connected to a (second) winding start 2V1-200 of a second secondary-side winding 2V of the second electric arc furnace transformer 200. A (second) winding end 2V2-200 of the second secondary-side winding 2V of the second electric arc furnace transformer 200 is connected to a (third) winding start 2W1-200 of the third secondary-side winding 2W of the second electric arc furnace transformer 200.

The low voltage connectors and winding starts and winding ends 2U1-100 and 2W2-100, 2U2-100 and 2V1-100, 2V2-100 and 2W1-100, respectively, of the first electric arc furnace transformer 100, which are correspondingly connected to each other in pairs, are interconnected (connected) in parallel with the corresponding low voltage connectors and winding starts and winding ends 2U1-200 and 2W2-200, 2U2-200 and 2V1-200, 2V2-200 and 2W1-200, respectively, of the second electric arc furnace transformer 200, which are connected to each other in pairs. That is, the winding start 2U1-100 and the winding end 2W2-100 are interconnected in parallel with the winding start 2U1-200 and the winding end 2W2-200 at node 2; the winding end 2U2-100 and the winding start 2V1-100 are interconnected in parallel with the winding end 2U2-200 and the winding start 2V1-200 at node 1; the winding end 2V2-100 and the winding start 2W1-100 are interconnected in parallel with the winding end 2V2-200 and the winding start 2W1-200 at node 3, as shown in FIG. 3. In this low voltage-side parallel circuit 400 outside of the transformers, the corresponding voltages are at the nodes 1, 2 and 3.

An electric arc furnace 10 operated with three-phase current comprises the above-mentioned three electrodes 11, 12, 13. The nodes 1, 2, 3 of the parallel circuit 400 are respectively connected to the electrodes 11, 12, 13 of the electric arc furnace 10 via lines 111, 112, 113.

The parallel circuit 400 and the electric arc furnace 10 are schematically illustrated in FIG. 1. In FIG. 1, in accordance with the illustration in one-line view, only one output connector of the furnace transformers 100, 200 and one electrode of the electric arc furnace 10 and one line are respectively illustrated, but, of course, there are respectively three in accordance with the three-phase operation.

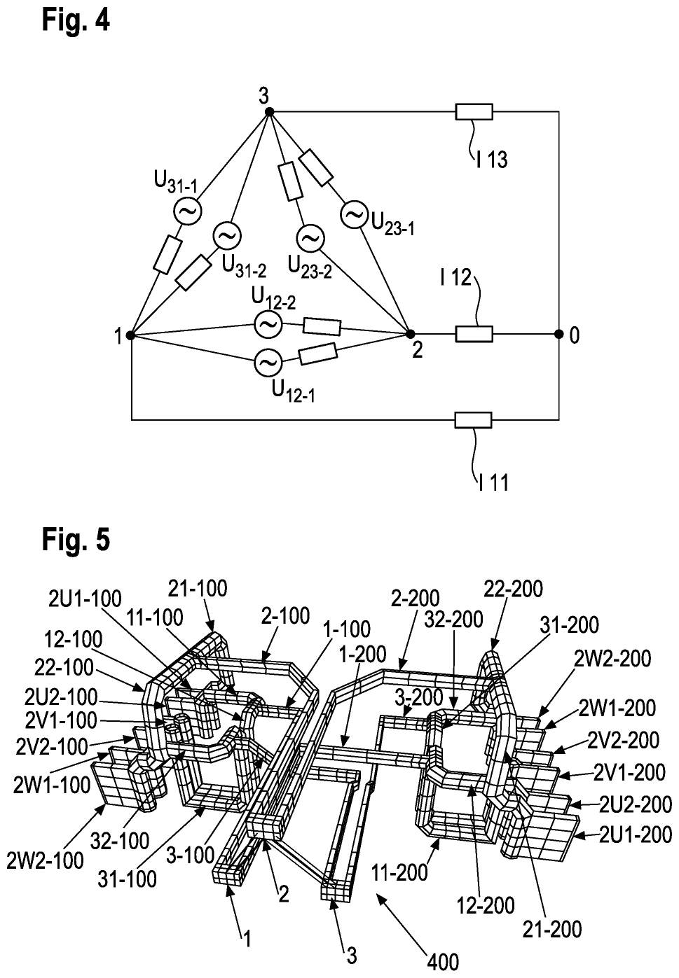

FIG. 4 shows a secondary-side electrical equivalent circuit diagram (ECD) of the furnace transformers of FIGS. 1 and 3 interconnected in parallel. Per each delta branch of the external secondary-side transformer interconnection, two voltage sources, namely U12-1, U12-2, and U23-1, U23-2, and U31-1, U31-2, respectively, are present instead of only one voltage source per delta branch as in the normal (conventional) case in which only one furnace transformer is utilized to supply current to the electrodes 11, 12, 13. The boxes shown in FIG. 4 next to the voltage sources represent the decoupled impedances of the high current conductors. The boxes denoted with I 11, I 12, and I 13 represent the impedances of the corresponding electrodes 11, 12, and 13 and their connection lines 111, 112, 113 to the nodes 1, 2, and 3. The node denoted with 0 represents the electric neutral point in the melting material, which is conductively connected to the electrical ground of the furnace vessel of the electric arc furnace 10.

The power supply device for metallurgical equipment of FIG. 1, which is to be operated (powered) with electric energy (current), comprises the two structurally equivalent, preferably identical, supply transformers 160, 260, each having a power rating of 100 MVA, which is related to ONAN-type cooling (Oil Natural Air Natural). By equipping the transformer with ONAF cooling (e.g., installed fans), the extractable power can be increased by a specified value, e.g., +20% or +30%.

A third structurally equivalent, preferably identical, supply transformer 360 is preferably set up as a spare to be used in case of failure (outage, breakdown) of one of the two other supply transformers 160, 260; i.e. the defective supply transformer can be replaced with the third supply transformer 360 with minimal downtime.

The supply transformers 160, 260 transform the input voltage from 400 kV or 220 kV to a medium voltage of 33 kV to 35 kV, which is usual for the operation of furnace transformers at their output-side medium voltage connectors 160m, 260m for the three phases. These are connected to the medium voltage furnace bar 140.

In such an input, only standard components can be utilized, which is an obvious advantage for electrical servicing and maintenance. A semiconductor-based non-active current compensator is connected to the medium voltage furnace bar 140 for voltage stability, flicker migration or power factor correction and is, e.g., configured as a 220 MVA STATCOM (Static Synchronous Compensator) 150, e.g., as a power factor corrector. The STATCOM 150 is connected to the medium voltage furnace bar 140 and can, e.g., optionally and advantageously, also be used to compensate non-active currents (reactive currents or reactive power) of the common bar (rolling mill, steel mill, etc.) to a certain degree when the common bar is connected to the same high voltage bar as the electric arc furnaces. STATCOM is an established technology that is capable of fulfilling the requirements with respect to limit (boundary) values of the energy supply (flicker, harmonics, asymmetry). Herein, the terms “non-active current compensator”, “reactive current compensator” and “reactive power compensator” are intended to be synonymous.

Optionally, one or more ladle furnaces (LF) also can be connected to the medium voltage furnace bar 140. More precisely, one or more ladle furnace transformers appropriate for the ladle furnace(s) may be connected to the medium voltage furnace bar 140. Depending on the power requirements of the ladle furnace(s), the power rating of the supply transformers 160, 260 would have to be adapted as appropriate.

The power supply device comprises the two structurally equivalent, preferably identical, three-phase electric arc furnace transformers 100, 200 each having a power rating of 100 MVA. The electric arc furnace transformers 100, 200 are cooled by OFWF (Oil Forced Water Forced) cooling. A third structurally equivalent, preferably identical, three-phase electric arc furnace transformer 300 is preferably set up as a spare.

Each of the electric arc furnace transformers 100, 200 is separately fed (energized) and has an output switch at the common medium voltage furnace bar 140 as well as a furnace switch 110, 210.

Ideally, a furnace switch is employed to avoid the strong inrush current of the transformer, which will always occur otherwise. This extends the lifetime of the transformers and reduces the burden or load of the overall feeding (energization).

In the embodiment shown, the two three-phase electric arc furnace transformers 100, 200 are respectively connected to the medium voltage furnace bar 140 via furnace switches such as, e.g., VCB switches (VCB=Vacuum Circuit Breaker) 110, 210.

Conventional three-phase electric arc furnace transformers comprise tap changers that adjust the secondary voltages of the transformers at the high current system under load. The synchronization of the tap changers of both electric arc furnace transformers is to be ensured. This is no problem in terms of control techniques.

The two furnace transformers are preferably arranged (disposed) such that the low voltage-side connectors oppose (face) each other between the furnace transformers, as shown in FIG. 3. The furnace transformers are positioned, therein, on a lateral side (lateral sides) of the electric arc furnace 10. This physical arrangement of the transformers 100, 200 and electric arc furnace 10 not only saves space, but also facilitates replacement. In FIG. 3, rails (structural supporting members, which may be embodied, e.g., as parallel bars or tracks) 100s for the one furnace transformer 100 are shown, via which the corresponding furnace transformer 100 can be driven (moved) to its position. In FIG. 3, rails 200s (similar to rails 100s) for the other furnace transformer 200 are also shown, via which the corresponding other furnace transformer 200 can be driven (moved) to its position, which opposes the position of the one furnace transformer 100, as described, on the one lateral side of the furnace 10. In FIG. 3, cooling systems are denoted with 100k and 200k. In the furnace transformers 100, 200 shown in FIG. 3, the cooling systems 100k and 200k are arranged on a (e.g., only one) lateral side of the furnace transformers 100, 200; but, of course, furnace transformers 100, 200, in which cooling systems are present on both lateral sides or at another location, also could be used.

Theoretically, the furnace transformers could stand next to each other in a conventional manner. However, in this case, substantially more constructional width (i.e. a larger footprint) would be required.

The mass of a 100 MVA furnace transformer is about 130 t. Therefore, such a furnace transformer 100, 200 is relatively easily transportable as well as mountable and demountable, e.g., using a normal truck-mounted crane and typically even using the charging crane of the existing steel factory.

The ladle size of integrated steel factories is about 180 t to 250 t. Therefore, e.g., for 220 t of liquid steel, it is necessary for the metallurgical equipment that is intended to replace a corresponding converter to also be capable of tapping, e.g., 200 t of liquid steel from a single piece of metallurgical equipment, e.g., a single electric arc furnace (EAF) 10. In this case, very large amounts of electric power are necessary for melting scrap and DRI (HBI) in order to achieve the required TTT (Tap-to-Tap Time=time between two taps), in particular because converters are usually faster than EAFs. During operation of an EAF having a tapping mass of 180 t to 250 t, electric power in the range of 180 MVA or more is required. A 180 MVA furnace transformer would, for example, be dimensioned for a maximum current intensity of 115 kA, which would require electrodes having a 750 mm diameter.

A 180 MVA single furnace transformer would already have a mass of at least 200 t and a maximum current intensity of about 115 kA. The necessary conductor cross-sections in the transformer for current intensities of 100 kA or more are problematic because of the current displacement and cooling.

The described parallel circuit of two identical furnace transformers with external parallel delta interconnection Diii halves the current intensity in the corresponding parallel conductors up to the nodes 1, 2, 3.

An electrically symmetric configuration of the parallel furnace transformer system is possible in embodiments according to the present disclosure. Preferably, each transformer winding conducts the same amount (value) of delta branch current such that the transformer windings (coils) are loaded symmetrically with the same amounts (values) of electrode currents. The high current system of the electric arc furnace is to be factored in for a final design of the geometry of the lines. Such a design can be made, e.g., using a simulation of the electric network according to a particular method for the field calculation of electromagnetic fields. Thus, the impedances of the entire high current system can be calculated with high accuracy with all current displacement effects (e.g., skin effects and/or proximity effects) and designed electrically symmetrical. An example of such a method is the Finite Network Method (FNM) (see, e.g., Abbas Farschtschi, “Neuartiges Berechnungssystem löst elektromagnetische Probleme an Elektrolichtbogenöfen”, stahl und eisen 131 (2011) Nr. 6/7, pages 93 to 104, or Abbas Farschtschi, “An advanced computation system to solve electromagnetic problems in arc furnaces” www.steeltimesint.com, Steel Times International, September 2011). Here, the term “electrically symmetric” means ≤3%. The electrical symmetry in percent is calculated from the equivalent star reactances of the conductor arrangement of the high current system X₁, X₂, X₃ to the equation Ux=(X_max−X_min)/X_mean, where X denotes the reactance in mOhm. Thus, preferably Ux≤3%. The value Ux is related to the standard configuration of the high current system, which has identical electrode lengths below the holders.

FIG. 5 shows an electrically symmetric arrangement of water-cooled high current conductors in the secondary-side high current system for a low voltage-side parallel circuit of the output-side low voltage connectors of two electric arc furnace transformers having symmetrized external delta interconnections, as shown in FIG. 3, which can be, e.g., designed using a simulation of the currents in the conductors. The same elements as in FIG. 3 are denoted by the same reference signs and a description of the same is not repeated. The water-cooled high current conductors are typically copper pipes (hereinafter, “Cu pipe(s)”) designed for an average current density of 6 A/mm². The wall thicknesses and diameters of the Cu pipes are selected accordingly. For example, pipes having wall thicknesses of 10 to 15 mm such as, e.g., 12.5 mm, and diameters from 140 mm to 250 mm such as, e.g., 140 mm or 160 mm or 180 mm or 200 mm or 220 mm or 240 mm, or in any range having any of those values as a starting point or ending point, can be selected depending on the current intensities. The pipes are preferably routed horizontally in parallel in at least two parallel horizontal planes and vertically in at least two parallel vertical planes, both because of the cable mounting and for maintaining corresponding distances of the pipes at lengths as equal as possible. In FIG. 5, there are four parallel horizontal planes and five parallel vertical planes. The number of these planes is, however, not important and can be suitably selected in adaptions (modifications) of the design (present teachings).

In greater detail, as illustrated in FIG. 5, the (first) winding start 2U1-100 of the first secondary-side winding 2U of the first electric arc furnace transformer 100 of the two electric arc furnace transformers 100, 200 is connected to the (third) winding end 2W2-100 of the third secondary-side winding 2W of the first electric arc furnace transformer 100 via a Cu pipe 21-100 and a Cu pipe 22-100 connected thereto. The (first) winding end 2U2-100 of the first secondary-side winding 2U of the first electric arc furnace transformer 100 is connected to the (second) winding start 2V1-100 of the second secondary-side winding 2V of the first electric arc furnace transformer 100 via a Cu pipe 11-100 and a Cu pipe 12-100 connected thereto. The (second) winding end 2V2-100 of the second secondary-side winding 2V of the first electric arc furnace transformer 100 is connected to the (third) winding start 2W1-100 of the third secondary-side winding 2W of the first electric arc furnace transformer 100 via a Cu pipe 31-100 and a Cu pipe 32-100 connected thereto. This arrangement results in three pairwise connections that form an external delta vector group.

In the same manner, in the second electric arc furnace transformer 200 of the two electric arc furnace transformers 100, 200, as also shown in FIG. 3, the (first) winding start 2U1-200 of the first secondary-side winding 2U of the second electric arc furnace transformer 200 is connected to the (third) winding end 2W2-200 of the third secondary-side winding 2W of the second electric arc furnace transformer 200 via a Cu pipe 21-200 and a Cu pipe 22-200 connected thereto. The (first) winding end 2U2-200 of the first secondary-side winding 2U of the second electric arc furnace transformer 200 is connected to the (second) winding start 2V1-200 of the second secondary-side winding 2V of the second electric arc furnace transformer 200 via a Cu pipe 11-200 and a Cu pipe 12-200 connected thereto. The (second) winding end 2V2-200 of the second secondary winding 2V of the second electric arc furnace transformer 200 is connected to the (third) winding start 2W1-200 of the third secondary-side winding 2W of the second electric arc furnace transformer 200 via a Cu pipe 31-200 and a Cu pipe 32-200 connected thereto. This arrangement also results in three pairwise connections that form an external delta vector group.

The Cu pipes and winding starts and winding ends 2U1-100 and 2W2-100, 2U2-100 and 2V1-100, 2V2-100 and 2W1-100, respectively, of the first electric arc furnace transformer 100, which are correspondingly connected to each other in pairs, are interconnected (connected) with the corresponding Cu pipes and winding starts and winding ends 2U1-200 and 2W2-200, 2U2-200 and 2V1-200, 2V2-200 and 2W1-200, respectively, of the second electric arc furnace transformer 200, which are connected to each other in pairs, in parallel. The arrangement results in a parallel connection of the two external delta vector groups. This parallel connection is achieved, as shown in FIG. 5, because:
Cu pipe 2-100 connects the Cu pipes 21-100 and 22-100 to the node 2 and Cu pipe 2-200 connects the Cu pipes 21-200 and 22-200 to the node 2, thereby forming one loop,
Cu pipe 1-100 connects the Cu pipes 11-100 and 12-100 to the node 1 and Cu pipe 1-200 connects the Cu pipes 11-200 and 12-200 to the node 1, thereby forming another (second) loop, and
Cu pipe 3-100 connects the Cu pipes 31-100 and 32-100 to the node 3 and Cu pipe 3-200 connects the Cu pipes 31-200 and 32-200 to the node 3, thereby forming yet another (third) loop.

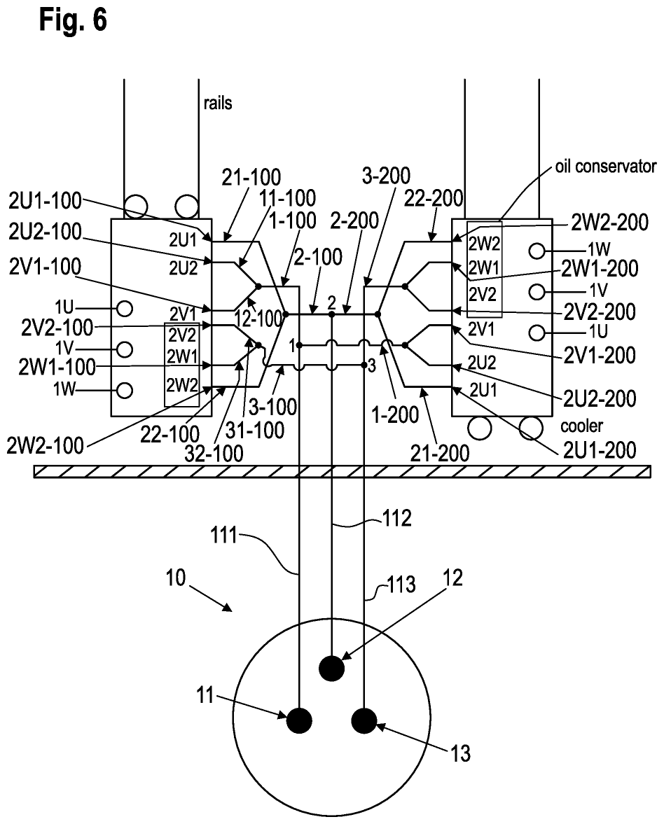

FIG. 6 shows the same schematic illustration of the electrical connections of the part of the power supply device shown in FIG. 3 with reference signs from FIG. 5 in order to illustrate the correspondence of the electrical lines from FIG. 3 to the Cu pipes from FIG. 5. An expansion tank (oil conservator), which holds oil used to cool the transformer, is schematically shown.

FIG. 2 shows a current supply device for metallurgical equipment to be operated (powered) with electric energy (current) with a non-linear load, such as an electric arc furnace according to a second embodiment. The same elements as in FIG. 1 are denoted by the same reference signs, and a description of the same is not repeated.

The second embodiment is designed for a very big EAF having, e.g., a 220 t tapping mass and a power consumption of up to 280 MVA. Therefore, the electrodes have diameters from 750 mm to 800 mm. Bigger electrodes having larger diameters are not presently available on the market. However, if larger furnace sizes and current intensities were to be required and bigger electrodes having a diameter of, e.g., 850 mm eventually become available, the same could be used as necessary in such a design. As shown in FIG. 2, the two structurally equivalent, preferably identical, electric arc furnace transformers 100, 200 each have a power rating of 140 MVA. The two supply transformers 160, 260 each have a power rating of 150 MVA. The high voltage supply bar 500 is connected to a common electric energy supply, e.g., via a 400 kV line 520 (or two 220 kV lines).

Different from the first embodiment of FIG. 1, in the second embodiment shown in FIG. 2, two medium voltage furnace bars 140a, 140b are respectively provided with separate semiconductor-based, 140 MVA non-active current compensations (non-active current compensators) (SVC+) 150a, 150b. These can also (instead) each be configured, e.g., as a 140 MVA STATCOM. Here, “SVC” stands for static VAR compensator. In this regard, it is noted that STATCOMs typically have a much better dynamic performance than SVCs; i.e. the disturbances created by the arc furnace are typically better eliminated by a STATCOM.

Thus, a STATCOM may be required for high power furnaces depending on the supply network conditions and required compliance with flicker and/or harmonic limits. However, in other embodiments of the present teachings, a less expensive SVC may be utilized to perform one or more of these functions. Thus, STATCOMs and SVCc are representative, non-limiting examples of non-active current compensators according to the present teachings.

With respect the two supply transformers 160, 260, the output-side medium voltage connectors 160m, 260m of each are respectively connected to a corresponding one of the medium voltage furnace bars 140a, 140b, as can be seen in FIG. 2; i.e. the supply transformer 160 is connected to the medium voltage furnace bar 140a and the supply transformer 260 is connected to the medium voltage furnace bar 140b.

The structures of the two structurally equivalent, preferably identical, electric arc furnace transformers 100, 200 and the low voltage-side parallel circuit 400 were already explained above with reference to FIGS. 1, 3, 4, 5.

The medium voltage furnace bar 140 of the power supply device is usually operated in a medium voltage range of 25 kV to 40 kV, preferably 30 kV to 35 kV, more preferably 33 kV to 35 kV, and the furnace transformers 100, 200 are respectively designed for the respective range that is implemented in a particular application of the present teachings.

The output of the low voltage-side parallel circuit 400 of the power supply device is usually operated in a low voltage range of 1000 V to 2000 V, preferably 1100 V to 1800 V, more preferably 1100 V to 1600 V, such as, e.g., in a range of 1000 V to 1400 V or in a range of 1100 V to 1600 V, and the furnace transformers 100, 200 are respectively designed for the respective range that is implemented in a particular application of the present teachings. Thus, the voltage range for the low voltage output denotes the possible settings of the furnace transformers using tap changers.

The high voltage supply bar 500 of the power supply device is usually operated in a high voltage range of 400 kV to 150 kV, preferably 400 to 380 kV or 180 kV to 220 kV, and the supply transformers 160, 260 are respectively designed for the respective range that is implemented in a particular application of the present teachings.

With a power supply device as described above, it is possible to operate very big EAFs having tapping masses of ≥180 t such as, e.g., 200 t or 220 t or 250 t, and to thereby avoid the disadvantages of very big furnace transformers.

In principle, furnace transformers for three-phase electric arc furnaces having a power rating greater than 180 MVA are currently manufacturable and some have already been installed. The biggest constructed furnace transformer has a power rating of about 300 MVA. Such gigantic units, however, have significant disadvantages, such as:
1) The manufacturing is not routine and very complicated. There are few manufacturers capable of reliably constructing such orders of magnitude. The constructional size is limited by the crane capacities in the manufacturing factory and by the size of the active part drying furnaces. In addition, such furnace transformers are highly specialized equipment requiring particular know-how in the engineering and in the manufacturing thereof, and the market for such extremely large furnace transformers is small.
2) Such large power outputs always require an intermediate circuit design (booster) comprising two iron cores with windings and, as a result, are very big and very difficult and/or expensive to build.
3) The total mass of such transformers amounts to at least 240 t. The big outer dimensions are also problematic. In particular, transportation from the manufacturer to the steel factory becomes very complicated.
4) The required conductor cross-sections of the windings for a greater than 100 kA electrode current require correspondingly big windings, which makes reliable cooling difficult.
5) The current intensities on the medium voltage busbar become so big (e.g., 3500 A for 200 MVA at 33 kV) that two parallel furnace switchgears may be required. The medium voltage cables have to be dimensioned accordingly large.
6) Even much more problematic are the transport, the mounting and upgrading (replacement) of such units. If a newly-built electric arc furnace is to be integrated into an existing integrated steel factory, the available space is often very limited. This makes a later replacement of a furnace transformer very difficult or even impossible. For example, it might be necessary for a 1000 t truck-mounted crane to lift a transformer over the hall roof (factory roof). The availability of such special cranes is very limited and waiting times of 6 months are rather typical.
7) The bigger and more complicated a transformer becomes, the greater is, in principle, the susceptibility to faults or defects. Generally speaking, more simple is more reliable. Experience has shown that furnace transformers can fail at any time and even have to be stopped before occurrence of a fatal error to remain, in principle, repairable. Then, the fast mounting of the spare is necessary to avoid a lengthy (unproductive) downtime. An identical spare is, therefore, required to be able to quickly return the EAF to operation. The giants among the furnace transformers are, however, practically only repairable in place (in situ) because transport back to the transformer factory is too expensive and/or complicated, in particular when the transformer comes from a foreign country. A repair in place and a replacement of windings and the subsequent high voltage testing, respectively, would be very expensive and/or complicated and/or time consuming. In the special case of an installed spare, a very big transformer house would be required to support about 480 t.

The significant advantages of a parallel circuit of two constructionally (structurally) equivalent, preferably constructionally (structurally) identical, smaller furnace transformers are, therefore, given. The manufacturing of, e.g., 100 . . . 120 MVA furnace transformers is routine in comparison. There are more manufacturers who can build such standard sizes. Such transformers are obviously less complicated, because they have, e.g., only one iron core with windings (no booster). The overall internal connection configuration is simpler. This improves reliability. Furthermore, the dimensions and the mass are substantially smaller. A 100 MVA furnace transformer has a total mass of about 130 t and is relatively easily transportable as well as mountable and demountable. Furnace transformers corresponding to a standard are cheaper. Because the furnace transformers are configured with open secondary windings and are delta interconnected externally (vector group Diii), they are structurally simpler, more reliable, lighter, and smaller. The two external delta interconnections are connected in parallel at their corner points. Up to the connection of these conductors, each side conducts only half of the total electrode current. The arrangement and routing of the conductors, respectively, in the high voltage system can be designed, e.g., using a simulation such that the entire high voltage system is electrically symmetric. This results, on average, in the same properties of the three electric arcs (power, radiation, length) and has significant operational advantages. It is very unlikely that both furnace transformers will fail at the same time. Therefore, one structurally equivalent, preferably identical, spare is sufficient.

The maximum power consumption of the metallurgical equipment (e.g., EAF) is preferably less than or equal to 320 MVA, more preferably less than or equal to 280 MVA, even more preferably less than or equal to 240 MVA.

The arrangements for the high voltage supply and the medium voltage supply described with reference to FIGS. 1 and 2 can also be replaced by other arrangements because, for the described and claimed low voltage-side configuration of the furnace transformers and their interconnection, the specific configuration of the arrangements for the high voltage-medium voltage supply is not relevant.

It is explicitly emphasized that all features disclosed in the description and/or claims are to be considered separate and independent from each other for the purpose of the original disclosure as well as for the purpose of limiting the claimed invention regardless of the combinations of features in the embodiments and/or claims. It is explicitly stated that all range indications or indications of groups of entities disclose any possible intermediate value or subgroup of entities for the purpose of the original disclosure as well as for the purpose of limiting the claimed invention, in particular also as a limit of a range indication.

1. A power supply device for metallurgical equipment, which is to be operated with electric energy with a non-linear load and has a maximum power consumption equal to or greater than 180 MVA, the power supply device comprising:
at least two structurally equivalent three-phase furnace transformers having an output power rating equal to or greater than 90 MVA, each of the furnace transformers comprising (i) an input-side three-phase medium voltage connector and a delta interconnection on an input side thereof and (ii) an output-side three-phase low voltage connector and an external interconnection on an output side thereof,
at least one medium voltage furnace bar connected to the input-side medium voltage connectors of the at least two furnace transformers, and
a low voltage-side parallel circuit connecting the output-side low voltage connectors of the furnace transformers via symmetrized external delta interconnections implemented as water-cooled high current conductors, the low voltage-side parallel circuit being configured to be connectable to electrodes of the metallurgical equipment.

2. The power supply device according to claim 1, further comprising:
at least one high voltage supply bar, and
at least two structurally equivalent supply transformers each having an output power rating equal to or greater than 90 MVA, each of the supply transformers comprising an input-side high voltage connector and an output-side medium voltage connector,
wherein the input-side high voltage connectors of the supply transformers are connected to the high voltage supply bar(s), and
the output-side medium voltage connectors of the supply transformers are connected to the at least one medium voltage furnace bar.

3. The power supply device according to claim 2, wherein the at least one medium voltage furnace bar comprises at least first and second medium voltage furnace bars respectively connected to the input-side three-phase medium voltage connectors of the at least two furnace transformers.

4. The power supply device according to claim 3, wherein the output-side medium voltage connectors of the supply transformers are respectively connected to the first and second medium voltage furnace bars.

5. The power supply device according to claim 4, further comprising:
at least one first non-active current compensator connected to the first medium voltage furnace bar, and
at least one second non-active current compensator connected to the second medium voltage furnace bar.

6. The power supply device according to claim 5, wherein the first and second non-active current compensators are each configured as semiconductor-based non-active current compensators.

7. The power supply device according to claim 6, wherein the water-cooled high current conductors are configured as water-cooled copper pipes respectively connected to the output-side three-phase low voltage connectors, each of the water-cooled copper pipes having one loop of predetermined length such that the predetermined lengths of the high current conductors within the three loops are electrically symmetrized.

8. The power supply device according to claim 2, further comprising:
at least one non-active current compensator connected to the at least one medium voltage furnace bar,
wherein the at least one non-active current compensator is configured as a semiconductor-based non-active current compensator.

9. The power supply device according to claim 1, wherein the water-cooled high current conductors are configured as water-cooled copper pipes respectively connected to the output-side three-phase low voltage connectors, each of the water-cooled copper pipes having one loop of predetermined length such that the predetermined lengths of the high current conductors within the three loops are electrically symmetrized.

10. The power supply device according to claim 9, wherein the at least two three-phase furnace transformers are arranged opposing each other on a lateral side of the metallurgical equipment such that the output-side three-phase low voltage connectors oppose each other and the low voltage-side parallel circuit of the output-side low voltage connectors is arranged between the furnace transformers.

11. The power supply device according to claim 1, wherein the at least two three-phase furnace transformers are arranged opposing each other on a lateral side of the metallurgical equipment such that the output-side three-phase low voltage connectors oppose each other and the low voltage-side parallel circuit of the output-side low voltage connectors is arranged between the furnace transformers.

12. The power supply device according to claim 10, wherein the at least two structurally equivalent three-phase furnace transformers are of identical construction.

13. The power supply device according to claim 1, wherein the at least two structurally equivalent three-phase furnace transformers are of identical construction.

14. The power supply device according to claim 1, wherein the at least two structurally equivalent three-phase furnace transformers are three-phase electric arc furnace transformers.

15. The power supply device according to claim 1, wherein the metallurgical equipment is an electric arc furnace.

16. A steel melting apparatus comprising:
an electric arc furnace having three electrodes; and
the power supply device according to claim 7, wherein the low voltage-side parallel circuit is connected to the three electrodes of the electric arc furnace.

17. A steel melting apparatus comprising:
an electric arc furnace having three electrodes; and
the power supply device according to claim 1, wherein the low voltage-side parallel circuit is connected to the three electrodes of the electric arc furnace.

18. The steel melting apparatus according to claim 17, wherein the at least two structurally equivalent three-phase furnace transformers are of identical construction.

19. The steel melting apparatus according to claim 18, further comprising:
at least one high voltage supply bar, and
at least two structurally equivalent supply transformers each having an output power rating equal to or greater than 90 MVA, each of the supply transformers comprising an input-side high voltage connector and an output-side medium voltage connector,
wherein the input-side high voltage connectors of the supply transformers are connected to the high voltage supply bar(s), and
the output-side medium voltage connectors of the supply transformers are connected to the medium voltage furnace bar.

20. The steel melting apparatus according to claim 19, wherein the water-cooled high current conductors are configured as water-cooled copper pipes respectively connected to the output-side three-phase low voltage connectors, each of the water-cooled copper pipes having one loop of predetermined length such that the predetermined lengths of the high current conductors within the three loops are electrically symmetrized.
